(19) United States
(12) Patent Application Publication
(10) Pub. No.: US 2023/0185563 A1
(43) Pub. Date: Jun. 15, 2023

(54) VEHICLE MANAGEMENT SYSTEM AND VEHICLE MANAGEMENT METHOD

(71) Applicant: TOYOTA JIDOSHA KABUSHIKI KAISHA, Toyota-shi (JP)

(72) Inventor: Tomokazu MAYA, Nagoya-shi (JP)

(73) Assignee: TOYOTA JIDOSHA KABUSHIKI KAISHA, Toyota-shi (JP)

(21) Appl. No.: 17/964,272

(22) Filed: Oct. 12, 2022

(30) Foreign Application Priority Data
Dec. 10, 2021 (JP) 2021-200834

(51) Int. Cl. G06F 8/65; G06F 8/71; G07C 5/00

(52) U.S. Cl. CPC G06F 8/65; G06F 8/71; G07C 5/008

(57) ABSTRACT

In a server of a manufacturer of an ADK, a memory stores updating information for updating a version of a program for a processor of the ADK, and a CPU controls an external communication unit such that the updating information is transmitted to the ADK of a vehicle. In the ADK of the vehicle, the processor updates the version of the program stored in a corresponding memory using updating information received from the server via the external communication unit. In the vehicle, a VCIB detects an updated version of the program of the processor of the ADK and controls a DCM such that identification information indicating the detected version is transmitted to a server of a manufacturer of a VP. In the server of the manufacturer of the VP, the CPU recognizes the version indicated by the identification information received from the vehicle as an updated version.

### CROSS-REFERENCE TO RELATED APPLICATION

This application claims priority to Japanese Patent Application No. 2021-200834 filed on Dec. 10, 2021, incorporated herein by reference in its entirety.

### BACKGROUND

### 1. Technical Field

The present disclosure relates to a vehicle management system and a vehicle management method and particularly to a vehicle management system and a vehicle management method that are appropriate for management of a version of a program of an autonomous driving device for a vehicle.

### 2. Description of Related Art

In the related art, a vehicle in which a power system, a power supply system, and an autonomous driving system are mounted is known (for example, see Japanese Unexamined Patent Application Publication No. 2018-132015 (JP 2018-132015 A).

### SUMMARY

When a program of an autonomous driving device for a vehicle has a version suitable for the vehicle, it is possible to appropriately control the vehicle. Accordingly, there is a demand for appropriate management of a version of a program of the autonomous driving device.

The present disclosure provides a vehicle management system and a vehicle management method that can appropriately manage a version of a program of an autonomous driving device.

A vehicle management system according to an aspect of the present disclosure includes a first server, a second server, and a vehicle. The first server includes a first communication unit, a first control unit, and a first storage unit. The second server includes a second communication unit, a second control unit, and a second storage unit. The vehicle includes: a vehicle functioning unit having functions for running, rotating, and stopping; an autonomous driving device configured to be attachable to and detachable from the vehicle functioning unit, including a third communication unit configured to communicate with the first communication unit, at least one third control unit, and a third storage unit configured to store a program which is executed by the corresponding third control unit, and configured to issue an instruction for autonomous driving to the vehicle functioning unit; a fourth control unit configured to output a control command for controlling the vehicle functioning unit; and a fourth communication unit configured to communicate with the second communication unit.

The first storage unit of the first server is configured to store updating data for updating a version of the program of the third control unit, and the first control unit of the first server is configured to control the first communication unit such that the updating data is transmitted to the autonomous driving device of the vehicle. The third control unit of the autonomous driving device of the vehicle is configured to update the version of the program stored in the corresponding third storage unit using the updating data received from the first server by the third communication unit. The fourth control unit of the vehicle is configured to detect the version of the updated program of the third control unit and to control the fourth communication unit such that first identification information indicating the detected version is transmitted to the second server. The second control unit of the second server is configured to recognize the version indicated by the first identification information received from the vehicle by the second communication unit as an updated version.

With this configuration, the version of the program for the autonomous driving device of the vehicle updated using the updating data stored in the first server is recognized as an updated version by the second server. As a result, it is possible to provide a vehicle management system that can appropriately manage a version of a program of an autonomous driving device.

The first control unit of the first server may be configured to control the first communication unit such that second identification information indicating the version is transmitted to the second server whenever a new version of the program is prepared. The second control unit of the second server may be configured to store the new version indicated by the second identification information received from the first server by the second communication unit as an operable version in the second storage unit in addition to an old version, to determine whether the updated version is included in the operable version stored in the second storage unit, and to notify a manager of a result of determination of whether the updated version is included in the operable version.

With this configuration, whenever the new version of the program for the autonomous driving device of the vehicle is prepared by the second server, a new version is stored as an operable version in addition to the old version, and the manager is notified of the result of determination of whether the updated version of the program for the autonomous driving device of the vehicle is included in the operable version. As a result, it is possible to notify the manager of whether the updated version of the program for the automatic driving device of the vehicle is an operable version.

The second control unit of the second server may be configured to perform a process for stopping operation of the vehicle when it is determined that the updated version is not included in the operable version.

With this configuration, when the updated version of the program for the autonomous driving device of the vehicle is not an operable version, it is possible to stop the operation of the vehicle.

The fourth control unit of the vehicle may be configured to detect a version by acquiring the version of the program from the autonomous driving device before autonomous driving starts.

With this configuration, it is possible to start autonomous driving after it has been ascertained whether the updated version of the program for the autonomous driving device of the vehicle is an operable version.

A vehicle management method according to another aspect of the present disclosure is performed by a vehicle management system including a first server, a second server, and a vehicle. The first server includes a first communication unit, a first control unit, and a first storage unit. The second server includes a second communication unit, a second control unit, and a second storage unit. The vehicle includes: a vehicle functioning unit having functions for running, rotating, and stopping; an autonomous driving device configured to be attachable to and detachable from the vehicle functioning unit, including a third communication unit configured to communicate with the first communication unit, at least one third control unit, and a third storage unit configured to store a program which is executed by the corresponding third control unit, and configured to issue an instruction for autonomous driving to the vehicle functioning unit; a fourth control unit configured to output a control command for controlling the vehicle functioning unit; and a fourth communication unit configured to communicate with the second communication unit.

The vehicle management method includes: causing the first control unit of the first server to control the first communication unit such that updating data for updating a version of the program for the third control unit, which is stored in the first storage unit, is transmitted to the autonomous driving device of the vehicle; causing the third control unit of the autonomous driving device of the vehicle to update the version of the program stored in the corresponding third storage unit using the updating data received from the first server by the third communication unit; causing the fourth control unit of the vehicle to detect the version of the updated program of the third control unit; causing the fourth control unit to control the fourth communication unit such that first identification information indicating the detected version is transmitted to the second server; and causing the second control unit of the second server to recognize the version indicated by the first identification information received from the vehicle by the second communication unit as an updated version.

With this configuration, it is possible to provide a vehicle management method that can appropriately manage a version of a program of the autonomous driving device.

According to the present disclosure, it is possible to provide a vehicle management system and a vehicle management method that can appropriately manage a version of a program of the autonomous driving device.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram schematically illustrating a configuration of a vehicle management system according to an embodiment of the present disclosure;

FIG. 2 is a diagram schematically illustrating a vehicle according to the embodiment of the present disclosure;

FIG. 3 is a diagram specifically illustrating configurations of an ADS, a VCIB, and a VP according to the embodiment of the present disclosure;

FIG. 4 is a flowchart illustrating a routine for managing a version of a program of an ADK in the vehicle management system according to a first embodiment; and

FIG. 5 is a flowchart illustrating a routine for managing a version of a program of an ADK in a vehicle management system according to a second embodiment.

### DETAILED DESCRIPTION OF EMBODIMENTS

### First Embodiment

Hereinafter, an embodiment of the present disclosure will be described in detail with reference to the accompanying drawings. The same or corresponding elements in the drawings will be referred to by the same reference signs and description thereof will not be repeated.

### Entire Configuration

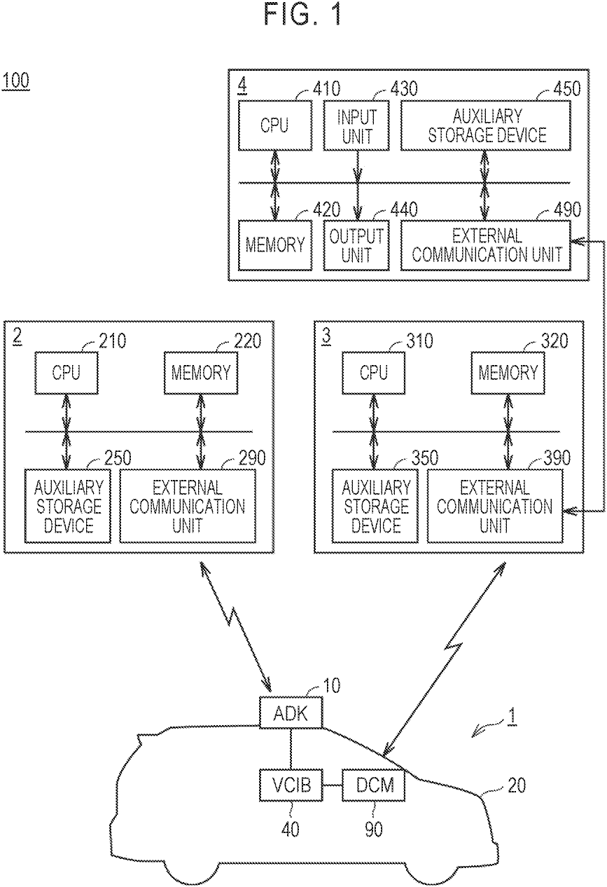

FIG. 1 is a diagram schematically illustrating a configuration of a vehicle management system 100 according to an embodiment of the present disclosure. Referring to FIG. 1, a vehicle 1 includes a vehicle platform (VP) 20 that has a function for running, rotating, and stopping and an autonomous driving kit (ADK) 10 that is attachable to and detachable from the VP 20 and issues an instruction for autonomous driving to the VP 20. The VP 20 includes a vehicle control interface box (VCIB) 40 that receives an instruction from the ADK 10 and controls the constituents of the VP 20 and a data communication module (DCM) 90 which is a communication device that can wirelessly communicate with an external device such as a server 3 of a manufacturer of the VP 20.

The vehicle management system 100 is a system for managing a plurality of vehicles 1. The vehicle management system 100 manages a version of a program for autonomous driving which is executed by the ADK 10 in this embodiment. The vehicle management system 100 includes a plurality of vehicles 1, a server 2 of a manufacturer of the ADK 10 of the corresponding vehicles 1, the server 3, and a server 4 of an operation manager of the corresponding vehicles 1.

The operation manager runs a predetermined business (for example, a business of transporting baggage or passengers) by operating a plurality of vehicles 1. The manufacturer of the VP 20 manages and controls the VP 20. The manufacturer of the ADK 10 manages and controls the ADK 10.

The server 4 includes a central processing unit (CPU) 410, a memory 420, an input unit 430, an output unit 440, an auxiliary storage device 450, and an external communication unit 490 that can communicate with an external device through wireless communication or wired communication. The memory 420 is constituted by a read only memory (ROM) and a random access memory (RAM) and stores programs which are executed by the CPU 410 and data which is used in the programs. The input unit 430 includes, for example, a keyboard and a mouse and receives an input of predetermined information or a predetermined operation to the server 4. The output unit 440 includes, for example, a display and a speaker and outputs predetermined information from the server 4. The auxiliary storage device 450 assists with the memory 420 and stores programs and data of a large capacity.

The CPU 410 processes data stored in the memory 420 or the auxiliary storage device 450, data input from the input unit 430, or data received from an external device by the external communication unit 490 in accordance with a program stored in the memory 420 or the auxiliary storage device 450, stores the processed data in the memory 420 or the auxiliary storage device 450 or outputs the processed data from the output unit 440, or transmits the processed data to an external device via the external communication unit 490.

The elements in the servers 2 and 3 having the same names as in the server 4 are the same devices as in the server 4. The servers 2 and 3 do not include an input unit or an output unit in FIG. 1, but they may include an input unit and an output unit.

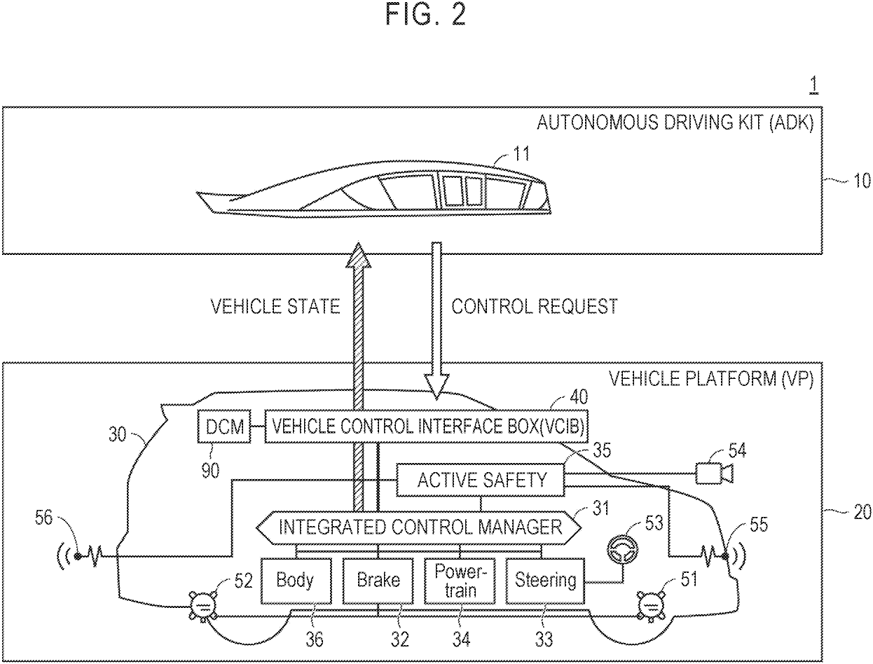

FIG. 2 is a diagram schematically illustrating the configuration of a vehicle 1 according to the embodiment of the present disclosure. As described above, the vehicle 1 includes an ADK 10 and a VP 20. The ADK 10 is configured to be attached to the VP 20 (to be attached to and detached from the vehicle 1). The ADK 10 and the VP 20 are configured to perform communication with each other via the VCIB 40.

The VP 20 can perform autonomous driving in response to a control request from the ADK 10. In FIG. 2, the ADK 10 is separated from the VP 20, but the ADK 10 is actually attached to a rooftop of the VP 20 or the like. The ADK 10 can be detached from the VP 20. When the ADK 10 is detached, the VP 20 performs travel control in a manual mode (travel control based on a user operation).

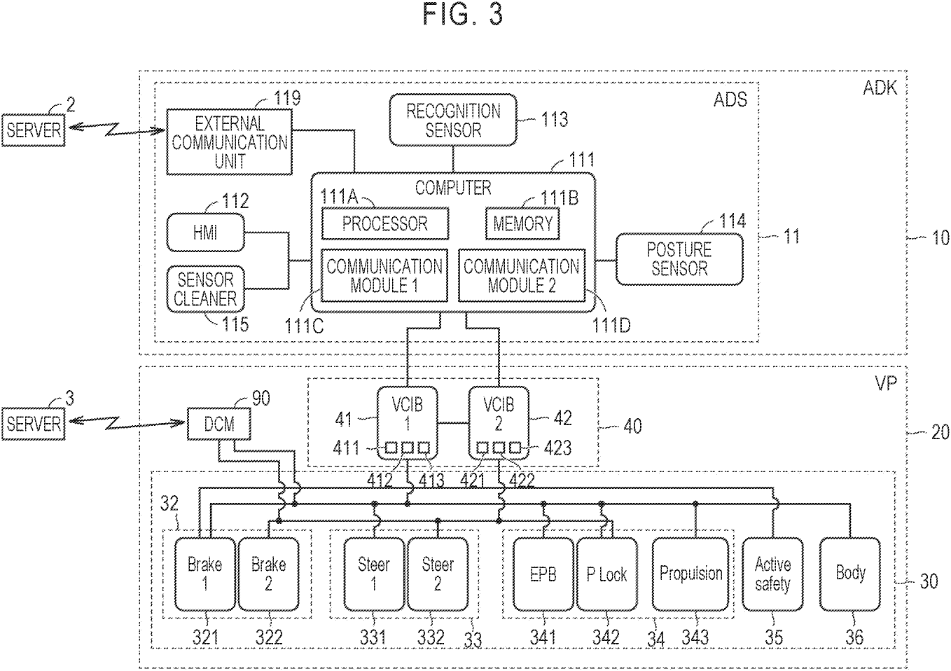

The ADK 10 includes an autonomous driving system (ADS) 11 that performs autonomous driving of the vehicle 1. For example, the ADS 11 prepares a travel plan of the vehicle 1. The ADS 11 outputs various control requests for causing the vehicle 1 to travel based on the travel plan to the VP 20 according to an application program interface (API) which is defined for each control request. The ADS 11 receives various signals indicating a vehicle state (a state of the VP 20) from the VP 20 according to an API defined for each signal. The ADS 11 reflects the vehicle state in the travel plan. The detailed configuration of the ADS 11 will be described later with reference to FIG. 3.

The VP 20 includes a base vehicle 30 and a VCIB 40. The base vehicle 30 performs various types of vehicle control in response to a control request from the ADK 10 (the ADS 11). The base vehicle 30 includes various systems and various sensors used to control the base vehicle 30. More specifically, the base vehicle 30 includes an integrated control manager 31, a brake system 32, a steering system 33, a power-train system 34, an active safety system 35, a body system 36, wheel speed sensors 51 and 52, a pinion angle sensor 53, a camera 54, and radar sensors 55 and 56.

The integrated control manager 31 includes a processor such as a CPU and a memory such as a ROM and a RAM, none of which is illustrated, and integrally controls the systems (the brake system 32, the steering system 33, the power-train system 34, the active safety system 35, and the body system 36) associated with the operation of the vehicle 1.

The brake system 32 is configured to control a brake device which is provided in each wheel of the base vehicle 30. The brake device includes, for example, a disc brake system (not illustrated) that operates with a hydraulic pressure which is adjusted by an actuator.

The wheel speed sensors 51 and 52 are connected to the brake system 32. The wheel speed sensor 51 detects a rotation speed of front wheels of the base vehicle 30 and outputs the detected rotation speed of the front wheels to the brake system 32. The wheel speed sensor 52 detects a rotation speed of rear wheels of the base vehicle 30 and outputs the detected rotation speed of the rear wheels to the brake system 32. The brake system 32 outputs the rotation speeds of the wheels as one piece of information included in the vehicle state to the VCIB 40. The brake system 32 generates a brake command for the brake device in response to a predetermined control request output from the ADS 11 via the VCIB 40 and the integrated control manager 31. The brake system 32 controls the brake device using the generated brake command. The integrated control manager 31 can calculate a speed (a vehicle speed) of the vehicle 1 based on the rotation speeds of the wheels.

The steering system 33 is configured to control a steering angle of a steering wheel (a turning angle of tires) of the vehicle 1 using a steering device. The steering device includes, for example, a rack-and-pinion type electric power steering (EPS) device that can adjust the steering angle using an actuator.

The pinion angle sensor 53 is connected to the steering system 33. The pinion angle sensor 53 detects a rotation angle (a pinion angle) of a pinion gear connected to a rotation shaft of an actuator and outputs the detected pinion angle to the steering system 33. The steering system 33 outputs the pinion angle as one piece of information included in the vehicle state to the VCIB 40. The steering system 33 generates a steering command for the steering device in response to a predetermined control request output from the ADS 11 via the VCIB 40 and the integrated control manager 31. The steering system 33 controls the steering device using the generated steering command.

The power-train system 34 controls an electric parking brake (EPB) system 341 that is provided in at least one of a plurality of wheels, a parking lock (P-lock) system 342 which is provided in a transmission of the vehicle 1, and a propulsion system 343 which includes a shift device (not illustrated) configured to select a shift range. The detailed configuration of the power-train system 34 will be described later with reference to FIG. 3.

The active safety system 35 detects an obstacle (such as a pedestrian, a bicycle, a parked vehicle, or a utility pole) on the front or rear side using the camera 54 and the radar sensors 55 and 56. The active safety system 35 determines whether there is a likelihood of collision of the vehicle 1 with an obstacle based on a distance between the vehicle 1 and the obstacle and a movement direction of the vehicle 1. When it is determined that there is a likelihood of collision, the active safety system 35 outputs a brake command to the brake system 32 via the integrated control manager 31 such that a braking force increases.

The body system 36 is configured to control components such as a direction indicator, a horn, and a wiper (none of which is illustrated), for example, based on a traveling state or environment of the vehicle 1. The body system 36 controls the components in response to a predetermined control request output from the ADS 11 via the VCIB 40 and the integrated control manager 31.

The VCIB 40 is configured to communicate with the ADS 11 via a controller area network (CAN) or the like. The VCIB 40 receives various control requests from the ADS 11 or outputs the vehicle state to the ADS 11 by executing a predetermined API defined for each signal. When a control request is received from the ADK 10, the VCIB 40 outputs a control command corresponding to the control request to a system corresponding to the control command via the integrated control manager 31. The VCIB 40 acquires various types of information of the base vehicle 30 from various systems via the integrated control manager 31 and outputs the state of the base vehicle 30 as the vehicle state to the ADS 11.

The vehicle 1 can be used as one constituent of a Mobility as a Service (MaaS) system. The MaaS system includes, for example, a data server and a mobility service platform (MSPF) (none of which is illustrated) in addition to the vehicle 1.

The MSPF is an integrated platform to which various mobility services are connected. A mobility service associated with autonomous driving is connected to the MSPF. In addition to the mobility service associated with autonomous driving, mobility services which are provided by a ride sharing company, a car sharing company, a car rental company, a taxi company, an insurance company, and the like may be connected to the MSPF.

As described above, the vehicle 1 further includes a DCM 90 that can wirelessly communicate with the data server. For example, the DCM 90 outputs vehicle information such as a speed, a position, and an autonomous driving state to the data server. For example, the DCM 90 receives various types of data for managing traveling of autonomous driving vehicles 1 including the vehicle in the mobility service associated with autonomous driving from the mobility service via the MSPF and the data server.

In the MSPF, an API which is required for development of the ADS 11 and which uses vehicle states and various types of data of vehicle control is published. Various mobility services may use various functions provided by the MSPF according to service details using the API published in the MSPF. For example, the mobility service associated with autonomous driving can acquire driving control data of the vehicle 1, information stored in the data server, and the like from the MSPF using the API published in the MSPF. The mobility service associated with autonomous driving can transmit data for management of the autonomous driving vehicles including the vehicle 1 or the like to the MSPF using the API.

### DETAILED CONFIGURATION

FIG. 3 is a diagram illustrating the configurations of the ADS 11, the VCIB 40, and the VP 20 according to this embodiment in detail. As illustrated in FIG. 3, the ADS 11 includes a computer 111, a human-machine interface (HMI) 112, a recognition sensor 113, a posture sensor 114, a sensor cleaner 115, and an external communication unit 119 that can wirelessly communicate with an external device such as the server 2.

The computer 111 includes a processor 111A such as a CPU and a memory 111B such as a ROM and a RAM. The memory 111B stores a program which can be executed by the processor 111A. The computer 111 acquires an environment of the vehicle 1 and a posture, behavior, and a position of the vehicle 1 using various sensors (which will be described later), acquires a vehicle state via the VP 20 and the VCIB 40, and sets a next operation of the vehicle 1 (such as accelerating, decelerating, turning, or stopping) at the time of performing autonomous driving of the vehicle 1. The computer 111 outputs various commands for realizing the next operation to the VCIB 40. The computer 111 further includes communication modules 111C and 111D. Each of the communication modules 111C and 111D is configured to communicate with the VCIB 40.

The HMI 112 presents information to a user or receives a user operation in autonomous driving, driving requiring a user operation, transitioning between autonomous driving and driving requiring a user operation, or the like. For example, the HMI 112 is connected to an input/output device (not illustrated) such as a touch panel display which is provided in the base vehicle 30.

The recognition sensor 113 is a sensor for recognizing the environment of the vehicle 1. The recognition sensor 113 includes, for example, at least one of a Laser Imaging Detection and Ranging (LIDAR) device, a millimeter wave radar, and a camera (none of which are not illustrated). For example, the LIDAR device emits laser light of infrared pulses and measures a distance and a direction of an object by detecting reflected light of the laser light from the object. The millimeter wave radar emits millimeter waves and measures a distance and a direction of an object by detecting reflected waves of the millimeter waves from the object. For example, the camera is disposed in the back of a rearview mirror and captures an image of a front view of the vehicle 1.

The posture sensor 114 is a sensor that detects a posture, behavior, and a position of the vehicle 1. The posture sensor 114 includes, for example, an inertial measurement unit (IMU) and a global positioning system (GPS) (none of which are illustrated). The IMU detects, for example, accelerations in a longitudinal direction, a lateral direction, and a vertical direction of the vehicle 1 and angular velocities in a roll direction, a pitch direction, and a yaw direction of the vehicle 1. The GPS detects the position of the vehicle 1 using information received from a plurality of GPS satellites going along an orbit of the earth.

The sensor cleaner 115 is configured to remove dirt which is attached to the various sensors (such as a lens of the camera or an emission part for laser light) while the vehicle 1 is traveling using a cleaning solution, a wiper, or the like.

The VCIB 40 includes a VCIB 41 and a VCIB 42. The VCIBs 41 and 42 include processors 411 and 421 such as a CPU, memories 412 and 422 such as a ROM and a RAM, and communication units 413 and 423 which are interfaces for communicating with the outside. The memory stores a program which can be executed by the processor. The communication unit 413 of the VCIB 41 and the communication module 111C are communicatively connected to each other. The communication unit 423 of the VCIB 42 and the communication module 111D are communicatively connected to each other. The communication unit 413 of the VCIB 41 and the communication unit 423 of the VCIB 42 are communicatively connected to each other.

Each of the VCIBs 41 and 42 relays a control request and vehicle information between the ADS 11 and the VP 20. More specifically, the VCIB 41 generates a control command based on the control request from the ADS 11 using an API.

Examples of the control command (command) corresponding to a control request supplied from the ADS 11 to the VCIB 40 include a propulsion direction command for requiring switching of a shift range, an immobility command for requiring activation/deactivation of the EPB system 341 and the P-lock system 342, an acceleration command for requiring acceleration or deceleration of the vehicle 1, a tire turning angle command for requiring a tire turning angle of the steering wheel, an automation command for requiring switching between an autonomous mode and a manual mode, and a stop command for requiring stopping or de-stopping of the vehicle.

The VCIB 41 outputs the generated control command to a corresponding system out of a plurality of systems included in the VP 20. The VCIB 41 generates information indicating the vehicle state from the vehicle information from the systems of the VP 20 using an API. The information indicating the vehicle state may be the same information as the vehicle information or may be information obtained by extracting information used for a process performed by the ADS 11 from the vehicle information. The VCIB 41 outputs the generated information indicating the vehicle state to the ADS 11. The same is true of the VCIB 42.

The brake system 32 includes brake systems 321 and 322. The steering system 33 includes steering systems 331 and 332. The power-train system 34 includes the EPB system 341, the P-lock system 342, and the propulsion system 343.

The VCIB 41 and the VCIB 42 basically have the same function, and the VCIB 41 and the VCIB 42 are different in a connection destination to a system included in the VP 20. Specifically, the VCIB 41, the brake system 321, the steering system 331, the EPB system 341, the P-lock system 342, the propulsion system 343, and the body system 36 are communicatively connected to each other via a communication bus. The VCIB 42, the brake system 322, the steering system 332, and the P-lock system 342 are communicatively connected to each other via a communication bus.

In this way, since the VCIBs 41 and 42 having the same functions for the operations (such as braking and steering) of some systems are provided in the VCIB 40, a control system of the ADS 11 and the VP 20 is made to be redundant. Accordingly, when a certain abnormality occurs in the corresponding systems, it is possible to maintain the function of the VP 20 by appropriately switching the control system or cutting off the control system in which an abnormality has occurred.

Each of the brake systems 321 and 322 is configured to control the brake device. The brake system 321 generates a brake command for the brake device in response to a control request output from the ADS 11 via the VCIB 41. The brake system 322 generates a brake command for the brake device in response to a control request output from the ADS 11 via the VCIB 42. The brake system 321 and the brake system 322 may have the same function. Alternatively, one of the brake systems 321 and 322 may be configured to independently control braking forces of the wheels and the other may be configured to perform control such that the same braking force is generated in the wheels. For example, the brake systems 321 and 322 may control the brake device using the brake command generated by one brake system and control the brake device using the brake command generated by the other brake system when an abnormality has occurred in the one brake system.

Each of the steering system 331 and 332 is configured to control the steering angle of the steering wheel of the vehicle 1 using the steering device. The steering system 331 generates a steering command for the steering device in response to a control request output from the ADS 11 via the VCIB 41. The steering system 332 generates a steering command for the steering device in response to a control request output from the ADS 11 via the VCIB 42. The steering system 331 and the steering system 332 may have the same function. Alternatively, for example, the steering systems 331 and 332 may control the steering device using the steering command generated by one steering system and control the steering device using the steering command generated by the other steering system when an abnormality has occurred in the one steering system.

The EPB system 341 controls the EPB in response to a control request output from the ADS 11 via the VCIB 41. The EPB is provided separately from the brake device (such as a disc brake system) and locks the wheels by operating an actuator. For example, the EPB locks the wheels by activating a drum brake for a parking brake provided in some of the plurality of wheels using an actuator or locks the wheels by activating the brake device using an actuator which can adjust a hydraulic pressure supplied to the brake device independently from the brake systems 321 and 322. The EPB system 341 has a brake holding function and is configured to switch between activation and deactivation of the brake holding function.

The P-lock system 342 controls a P-lock device in response to a control request output from the ADS 11 via the VCIB 41. For example, the P-lock system 342 activates the P-lock device when the control request includes a control request for setting the shift range to a parking range (a P range), and deactivates the P-lock device when the control request includes a control request for setting the shift range to a range other than the P range. The P-lock device causes a protrusion of a tip of a parking-lock pole of which can be positioned by an actuator to engage with teeth of a gear (a lock gear) provided to be connected to a rotary element of the transmission of the vehicle 1. Accordingly, rotation of an output shaft of the transmission is fixed and the wheels are locked.

The propulsion system 343 changes the shift range of the shift device or controls a driving force from a drive source (such as a motor generator or an engine) in response to a control request output from the ADS 11 via the VCIB 41. The shift range includes, for example, a neutral range (an N range), a forward range (a D range), and a reverse range (a R range) in addition to the P range.

The active safety system 35 is communicatively connected to the brake system 321. As described above, the active safety system 35 detects an obstacle in front using the camera 54 and/or the radar sensor 55 and outputs a brake command to the brake system 321 such that a braking force increases when it is determined that there is a likelihood of collision.

The body system 36 controls components such as a direction indicator, a horn, and a wiper in response to a control request output from the ADS 11 via the VCIB 41.

In the vehicle 1, for example, autonomous driving is performed when an autonomous mode is selected by a user’s operation of the HMI 112. As described above, first, the ADS 11 prepares a traveling plan when autonomous driving is being performed. Examples of the traveling plan include a plan for keeping going ahead straight, a plan for turning to left/right at a predetermined crossroad in the middle of a predetermined travel route, and a plan for changing the traveling lane. The ADS 11 calculates a controllable physical quantity (such as an acceleration, a deceleration, or a tire turning angle) required for the vehicle 1 to operate according to the prepared traveling plan. The ADS 11 divides the physical quantity for each execution cycle of an API. The ADS 11 outputs a control request indicating the divided physical quantities to the VCIB 40 using the API. The ADS 11 acquires the vehicle state (such as an actual movement direction of the vehicle 1 and a fixation state of the vehicle) from the VP 20 and re-prepares the traveling plan in which the acquired vehicle state is reflected. In this way, the ADS 11 enables autonomous driving of the vehicle 1.

### Management of Version of Program of ADK 10

The processor 111A of the computer 111 of the ADS 11 of the ADK 10 performs a predetermined process in accordance with a program stored in the memory 111B. Here, an example in which one processor 111A is provided in the computer 111 of the ADS 11 is described, but the number of processors provided in the computer 111 is not limited to one, but a plurality of processors may be provided. When two or more processors are provided, memories storing programs which are executed by the processors are provided to correspond thereto.

When the program of the ADK 10 of the vehicle 1 is a version suitable for the vehicle 1, it is possible to appropriately control the vehicle 1. On the other hand, when the program of the ADK 10 is not a version suitable for the vehicle 1, the vehicle 1 may not be appropriately controlled. Accordingly, it is necessary to appropriately manage the version of the program of the ADK 10.

Therefore, in the server 2 of the manufacturer of the ADK 10, the memory 220 or the auxiliary storage device 250 stores updating data for updating the version of the program of the processor 111A of the ADK 10, and the CPU 210 controls the external communication unit 290 such that the updating data is transmitted to the ADK 10 of the vehicle 1. In the ADK 10 of the vehicle 1, the processor 111A updates the version of the program stored in the corresponding memory 111B using the updating data received from the server 2 by the external communication unit 119. In the vehicle 1, the processors 411 and 421 of the VCIBs 41 and 42 detect a version of the updated program of the processor 111A of the ADK 10 and control the DCM 90 such that identification information indicating the detected version is transmitted to the server 3 of the manufacturer of the VP 20. In the server 3, the CPU 310 recognizes the version indicated by the identification information received from the vehicle 1 by the external communication unit 390 as the updated version.

Accordingly, the version of the program of the ADK 10 of the vehicle 1 which is updated using the updating data stored in the server 2 of the manufacturer of the ADK 10 is recognized as an updated version by the server 3 of the manufacturer of the VP 20. Accordingly, the version of the program of the ADK 10 can be managed by the server 3 of the manufacturer of the VP 20. As a result, it is possible to appropriately manage the version of the program of the ADK 10.

When the version of the program executed by the processor 111A of the ADK 10 has been updated by the manufacturer of the ADK 10, the manufacturer of the VP 20 generally ascertains whether the vehicle 1 operates appropriately at the time of introducing the program of the updated version into the ADK 10 attached to the vehicle 1.

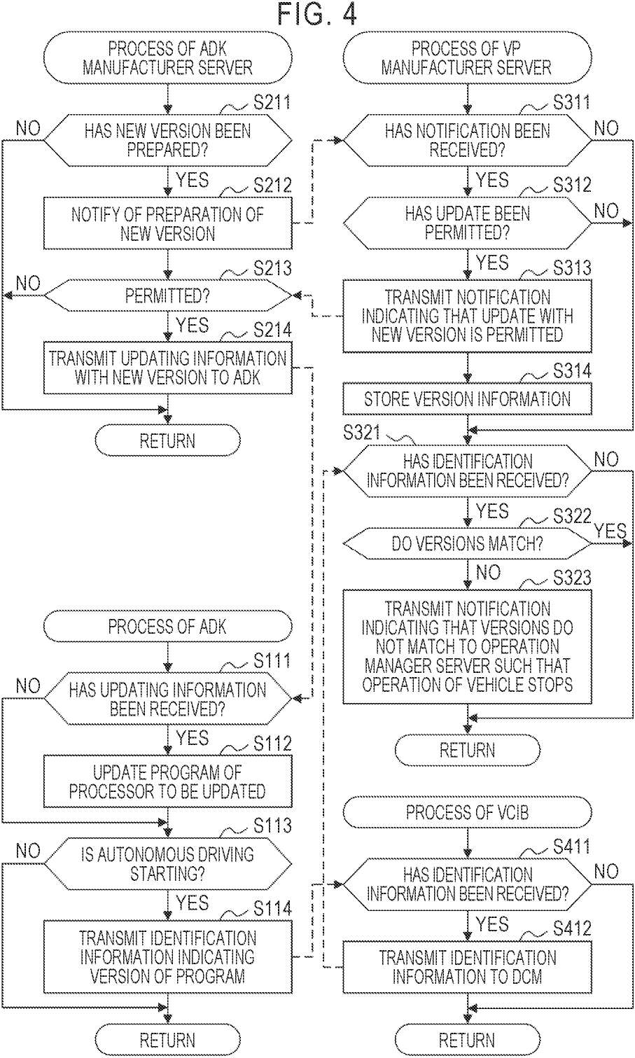

FIG. 4 is a flowchart illustrating a routine for managing a version of a program for the ADK 10 in the vehicle management system 100 according to the first embodiment. Referring to FIG. 4, the CPU 210 in the server 2 of the manufacturer of the ADK 10 determines whether preparation of a new version has been ascertained (Step S211). When it is determined that preparation of a new version has been ascertained (YES in Step S211), the CPU 210 controls the external communication unit 290 such that information indicating that a new version has been prepared and including information indicating the new version is transmitted to the server 3 of the manufacturer of the VP 20 (Step S212).

In the server 3 of the manufacturer of the VP 20, the CPU 310 determines whether a notification of information indicating that a new version has been prepared has been received from the server 2 of the manufacturer of the ADK 10 by the external communication unit 390 (Step S311). When it is determined that a notification of information indicating that a new version has been prepared has been received (YES in Step S311), the CPU 310 determines whether update with the new version is to be permitted by ascertaining that the vehicle 1 operates appropriately beforehand in an actual vehicle or in test based on simulation using the program of the new version (Step S312).

When it is determined that update with the new version is to be permitted (YES in Step S312), the CPU 310 controls the external communication unit 390 such that information indicating that update with the new version is permitted is transmitted to the server 2 (Step S313). Then, the CPU 310 adds information indicating the new version to operable version information indicating an operable version in the ADK 10 of the vehicle 1 and stores the resultant information in the memory 320 or the auxiliary storage device 350 (Step S314).

In the server 2 of the manufacturer of the ADK 10, the CPU 210 determines whether information indicating that update with the new version is permitted has been received from the server 3 of the manufacturer of the VP 20 by the external communication unit 290 (Step S213). When it is determined that information indicating that update with the new version is permitted has been received (YES in Step S213), the CPU 210 controls the external communication unit 290 such that updating information for updating the program of the processor 111A of the computer 111 of the ADK 10 with the new version is transmitted to the ADK 10 of the vehicle 1 (Step S214).

When it is determined that preparation of a new version has not been ascertained (NO in Step S211), when it is determined that information indicating that update with the new version is permitted has not been received (NO in Step S213), or when the process of Step S214 has been performed, the CPU 210 returns the current routine to the host routine.

In the ADK 10 of the vehicle 1, the processor 111A of the computer 111 of the ADS 11 determines whether updating information has been received from the server 2 of the manufacturer of the ADK 10 by the external communication unit 119 (Step S111). When it is determined that updating information has been received (YES in Step S111), the processor 111A updates the program of the processor 111A to be updated which is stored in the memory 111B using the updating information (Step S112).

The processor 111A determines whether it is time to start autonomous driving with the ADK 10 (Step S113). When it is determined that it is time to start autonomous driving (YES in Step S113), the processor 111A controls the communication modules 111C and 111D such that identification information indicating the version of the program executed in the processor 111A is transmitted to the VCIB 40 (Step S114).

When it is determined that it is not time to start autonomous driving (NO in Step S113) or when the process of Step S114 has been performed, the processor 111A returns the current routine to the host routine.

In the VCIB 40 of the VP 20 of the vehicle 1, the processors 411 and 421 of the VCIBs 41 and 42 determine whether identification information has been received from the ADK 10 by the communication units 413 and 423 (Step S411). When it is determined that identification information has been received (YES in Step S411), the processors 411 and 421 control the DCM 90 such that the received identification information is transmitted to the server 3 of the manufacturer of the VP 20 (Step S412).

When it is determined that identification information has not been received (NO in Step S411) or when the process of Step S412 has been performed, the processors 411 and 421 return the current routine to the host routine.

In the server 3 of the manufacturer of the VP 20, the CPU 310 determines whether identification information has been received from the VP 20 of the vehicle 1 by the external communication unit 390 (Step S321). When it is determined that identification information has been received (YES in Step S321), the CPU 310 determines whether the version of the updated program in the ADK 10 indicated by the received identification information matches an operable version in the ADK 10 of the vehicle 1 included in the operable version information stored in the memory 320 or the auxiliary storage device 350 (Step S322).

When it is determined that the updated version does not match the operable version (NO in Step S322), the CPU 310 controls the external communication unit 390 such that a notification indicating that the versions do not match is transmitted to the server 4 of the operation manager of the vehicle 1 in order to allow the operation manager to stop the operation of the vehicle 1 having transmitted the identification information (Step S323). The operation manager can perform a process for stopping the operation of the vehicle 1 based on the circumstances by receiving the notification indicating that the versions do not match. For example, the process for stopping the operation may be a process of instructing a driver to drive the vehicle to a repair shop in a manual driving manner when there is the driver in the vehicle 1, a process of driving the vehicle to a repair shop in an autonomous driving manner regardless of whether there is a driver, or a process of immediately stopping the operation of the vehicle.

When it is determined that identification information has not been received (NO in Step S321), when it is determined that the updated version matches the operable version (YES in Step S322), or when the process of Step S323 has been performed, the CPU 310 returns the current routine to the host routine.

Accordingly, when the version of the updated program in the ADK 10 of the vehicle 1 does not match the operable version which has been ascertained beforehand, it is possible to stop the operation of the vehicle 1. Accordingly, when the program for the ADK 10 has been updated with a version of which operability has not been ascertained intentionally by the manufacturer of the ADK 10 or with negligence or when the program for the ADK 10 has been illegally updated by a malicious third party, it is possible to stop the operation of the vehicle 1 before the vehicle 1 operates erroneously. As a result, it is possible to appropriately manage the version of the program for the ADK 10.

### Second Embodiment

In the first embodiment, the server 3 of the manufacturer of the VP 20 ascertains whether the version of an updated program is an operable version. In a second embodiment, the VCIBs 41 and 42 of the vehicle 1 ascertain whether the version of an updated program is an operable version.

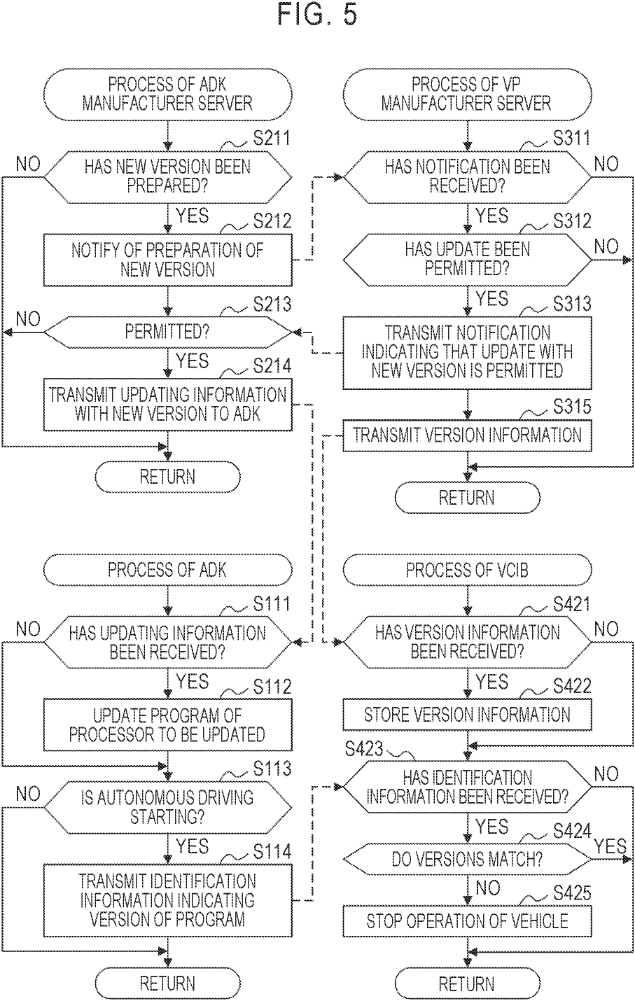

FIG. 5 is a flowchart illustrating a routine for managing a version of a program of an ADK 10 in a vehicle management system 100 according to the second embodiment. Referring to FIG. 5, the process details of the same step numbers as in FIG. 4 according to the first embodiment out of the steps illustrated in FIG. 5 are the same as the process details described above with reference to FIG. 4 and thus description thereof will not be repeated.

In the server 3 of the manufacturer of the VP 20, subsequently to Step S313 described above with reference to FIG. 4, the CPU 310 controls the external communication unit 390 such that version information indicating a new version of the program of the ADK 10 of the vehicle 1 is transmitted to the VCIB 40 of the vehicle 1.

In the VCIB 40 of the VP 20 of the vehicle 1, the processors 411 and 421 of the VCIBs 41 and 42 determine whether version information has been received from the server 3 by the communication units 413 and 423 (Step S421). When it is determined that version information has been received (YES in Step S421), information indicating the new version indicated by the received version information is added to operable version information indicating an operable version in the ADK 10 of the vehicle 1 and the resultant information is stored in the memories 412 and 422 of the VCIB 40 (Step S422).

The processors 411 and 421 of the VCIBs 41 and 42 determine whether identification information has been received from the ADK 10 by the communication units 413 and 423 (Step S423). When it is determined that identification information has been received (YES in Step S423), the processors 411 and 421 determine whether the version of the updated program of the ADK 10 indicated by the received identification information matches an operable version in the ADK 10 included in the operable version information stored in the memories 412 and 422 (Step S424).

When it is determined that the updated version does not match the operable version (NO in Step S424), the processors 411 and 421 perform a process for stopping the operation of the vehicle 1 (Step S425). For example, the process for stopping the operation of the vehicle 1 may be a process of instructing a driver to drive the vehicle to a repair shop in a manual driving manner when there is the driver in the vehicle 1, a process of controlling the constituents of the VP 20 such that the vehicle moves to a repair shop in an autonomous driving manner regardless of whether there is a driver, or a process of controlling the constituents of the VP 20 such that the operation of the vehicle immediately stops.

When it is determined that identification information has not been received (NO in Step S423), when it is determined that the updated version matches the operable version (YES in Step S424), or when the process of Step S425 has been performed, the processors 411 and 421 return the current routine to the host routine.

Accordingly, when the version of the updated program in the ADK 10 of the vehicle 1 does not match the operable version which has been ascertained beforehand, it is possible to stop the operation of the vehicle 1. Accordingly, when the program for the ADK 10 has been updated with a version of which operability has not been ascertained intentionally or with negligence by the manufacturer of the ADK 10 or when the program for the ADK 10 has been illegally updated by a malicious third party, it is possible to stop the operation of the vehicle 1 before the vehicle 1 operates erroneously. As a result, it is possible to appropriately manage the version of the program for the ADK 10.

### Modified Examples

(1) In the aforementioned embodiments, an example in which the number of processors 111A of the computer 111 of the ADK 10 is one has been described as illustrated in FIG. 3. However, the present disclosure is not limited thereto and the number of processors of the computer 111 of the ADK 10 may be two or more. In this case, programs corresponding to the plurality of processors may be stored in one memory 111B or may be stored in memories corresponding to the plurality of processors. In this case, the programs are independently updated.

(2) In the aforementioned embodiments, the servers 2 and 3 are the servers of the manufacturer of the ADK 10 and the manufacturer of the VP 20 as illustrated in FIG. 1. However, the present disclosure is not limited thereto and the servers 2 and 3 may be servers of other persons. For example, the servers 2 and 3 may be servers of sellers of the ADK 10 and the VP 20.

(3) In the aforementioned embodiments, the timing at which it is determined whether the version is appropriate is a time at which autonomous driving starts as illustrated in Step S113 or the like of FIGS. 4 and 5. However, the timing at which it is determined whether the version is appropriate is not limited thereto and may be another timing. The timing may be a time at which the vehicle 1 starts or a time at which manual driving is switched to autonomous driving.

(4) In the aforementioned embodiments, a control unit of the VP 20 side includes the processors 411 and 421 of the VCIBs 41 and 42 as illustrated in FIGS. 4 and 5. However, the present disclosure is not limited thereto and the control unit of the VP 20 may be another control unit. For example, the control unit may be the processor of the integrated control manager 31 illustrated in FIG. 2 or may be a processor of another ECU.

(5) In the aforementioned embodiments, the operation manager of the vehicle 1 is different from the manufacturer (or the seller) of the VP 20 as illustrated in FIG. 1. However, the present disclosure is not limited thereto and the operation manager of the vehicle 1 may be the same as the manufacturer (or the seller) of the VP 20.

(6) In the aforementioned embodiments, the ADK 10 and the VCIBs 41 and 42 are connected via the CAN. However, the present disclosure is not limited thereto and the ADK 10 and the VCIBs 41 and 42 may be connected using any connection system. The connection system may include an onboard communication network other than the CAN or may be a connection system using another communication method.

(7) The aforementioned embodiments can be understood as a disclosure of a device such as the server 2, 3, or 4, the vehicle 1, the ADK 10, the ADS 11, the VP 20, the base vehicle 30, or the VCIB 40, can understood as a disclosure of a system including two or more devices out of the devices, or can be understood as a disclosure of a method or a program in the devices or the systems.

### Conclusion

(1) As illustrated in FIG. 1, the vehicle management system 100 includes the server 2 of a manufacturer (or a seller) of the ADK 10, the server 3 of a manufacturer (or a seller) of the VP 20, and a vehicle 1. As illustrated in FIG. 1, the server 2 includes the external communication unit 290, the CPU 210, and the memory 220 (or the auxiliary storage device 250). As illustrated in FIG. 1, the server 3 includes the external communication unit 390, the CPU 310, and the memory 320 (or the auxiliary storage device 350). As illustrated in FIGS. 1 to 3, the vehicle 1 includes the VP 20 having functions for running, rotating, and stopping, the ADK 10 configured to be attachable to and detachable from the VP 20, including the external communication unit 119 configured to communicate with the external communication unit 290 of the server 2, at least one processor 111A, and the memory 111B configured to store a program which is executed by the corresponding processor 111A, and configured to issue an instruction for autonomous driving to the VP 20; the VCIB 40 configured to output a control command for controlling the VP 20; and the DCM 90 configured to communicate with the external communication unit 290 of the server 3.

As illustrated in FIGS. 4 and 5, the memory 220 (or the auxiliary storage device 250) of the server 2 of the manufacturer of the ADK 10 is configured to store updating information for updating the version of the program of the processor 111A of the ADK 10, and the CPU 210 is configured to control the external communication unit 290 such that the updating information is transmitted to the ADK 10 of the vehicle 1 (for example, Step S214). As illustrated in FIGS. 4 and 5, the processor 111A of the ADK 10 of the vehicle 1 is configured to update the version of the program stored in the corresponding memory 111B using the updating information received from the server 2 by the external communication unit 119 (for example, Step S112). As illustrated in FIG. 4, the VCIBs 41 and 42 of the vehicle 1 is configured to detect the version of the updated program of the processor 111A of the ADK 10 (for example, Step S411) and to control the DCM 90 such that identification information indicating the detected version is transmitted to the server 3 of the manufacturer of the VP 20 (for example, Step S412). As illustrated in FIG. 4, the CPU 310 of the server 3 of the manufacturer of the VP 20 is configured to recognize the version indicated by the identification information received from the vehicle 1 by the external communication unit 390 as an updated version (for example, Step S321).

Accordingly, the version of the program for the ADK 10 of the vehicle 1 updated using the updating information stored in the server 2 of the manufacturer of the ADK 10 is recognized as an updated version by the server 3 of the manufacturer of the VP 20. As a result, it is possible to appropriately manage a version of a program of the ADK 10.

(2) As illustrated in FIG. 4, the CPU 210 of the server 2 of the manufacturer of the ADK 10 is configured to control the external communication unit 290 such that information indicating the version is transmitted to the server 3 of the manufacturer of the VP 20 whenever a new version of the program is prepared (for example, Step S211 and Step S212). As illustrated in FIGS. 4 and 5, the CPU 310 of the server 3 of the manufacturer of the VP 20 is configured to store the new version indicated by the information received from the server 2 by the external communication unit 390 as an operable version in the memory 320 (or the auxiliary storage device 350) in addition to an old version (for example, Step S314), to determine whether the updated version is included in the operable version stored in the memory 320 (or the auxiliary storage device 350) (for example, Step S322), and to notify the server 4 of an operation manager of the result of determination of whether the updated version is included in the operable version (for example, Step S323).

Accordingly, whenever the new version of the program for the ADK 10 of the vehicle 1 is prepared by the server 2 of the manufacturer of the ADK 10, a new version is stored as an operable version in in addition to the old version, and the operation manager is notified of the result of determination of whether the updated version of the program for the ADK 10 of the vehicle 1 is included in the operable version. As a result, it is possible to notify the operation manager whether the updated version of the program for the ADK 10 of the vehicle 1 is an operable version.

(3) As illustrated in FIGS. 4 and 5, the CPU 310 of the server 3 of the manufacturer of the VP 20 is configured to perform a process for stopping operation of the vehicle 1 when it is determined that the updated version is not included in the operable version (for example, Step S323).

Accordingly, when the updated version of the program for the ADK 10 of the vehicle 1 is not an operable version, it is possible to stop the operation of the vehicle 1.

(4) As illustrated in FIGS. 4 and 5, the VCIBs 41 and 42 of the vehicle 1 is configured to detect a version by acquiring the version of the program from the ADK 10 before autonomous driving starts (for example, Step S411 and Step S423).

Accordingly, it is possible to start autonomous driving after it has been ascertained whether the updated version of the program for the ADK 10 of the vehicle 1 is an operable version.

It should be understood that the embodiments described above in the present disclosure are exemplary but not restrictive in all respects. The scope of the present disclosure is not defined by the aforementioned description of the embodiments, but is defined by the appended claims and is intended to include all modifications within meanings and scopes equivalent to the claims.

What is claimed is:

1. A vehicle management system comprising:
a first server;
a second server; and
a vehicle,
wherein the first server includes a first communication unit, a first control unit, and a first storage unit,
wherein the second server includes a second communication unit, a second control unit, and a second storage unit,
wherein the vehicle includes:
a vehicle functioning unit having functions for running, rotating, and stopping;
an autonomous driving device configured to be attachable to and detachable from the vehicle functioning unit, including a third communication unit configured to communicate with the first communication unit, at least one third control unit, and a third storage unit configured to store a program which is executed by the corresponding third control unit, and configured to issue an instruction for autonomous driving to the vehicle functioning unit;
a fourth control unit configured to output a control command for controlling the vehicle functioning unit; and
a fourth communication unit configured to communicate with the second communication unit,
wherein the first storage unit of the first server is configured to store updating data for updating a version of the program of the third control unit,
wherein the first control unit of the first server is configured to control the first communication unit such that the updating data is transmitted to the autonomous driving device of the vehicle,
wherein the third control unit of the autonomous driving device of the vehicle is configured to update the version of the program stored in the corresponding third storage unit using the updating data received from the first server by the third communication unit,
wherein the fourth control unit of the vehicle is configured to:
detect the version of the updated program of the third control unit; and
control the fourth communication unit such that first identification information indicating the detected version is transmitted to the second server, and
wherein the second control unit of the second server is configured to recognize the version indicated by the first identification information received from the vehicle by the second communication unit as an updated version.

2. The vehicle management system according to claim 1, wherein the first control unit of the first server is configured to control the first communication unit such that second identification information indicating the version is transmitted to the second server whenever a new version of the program is prepared, and
wherein the second control unit of the second server is configured to:
store the new version indicated by the second identification information received from the first server by the second communication unit as an operable version in the second storage unit in addition to an old version;
determine whether the updated version is included in the operable version stored in the second storage unit; and
notify a manager of a result of determination of whether the updated version is included in the operable version.

3. The vehicle management system according to claim 2, wherein the second control unit of the second server is configured to perform a process for stopping operation of the vehicle when it is determined that the updated version is not included in the operable version.

4. The vehicle management system according to claim 1, wherein the fourth control unit of the vehicle is configured to detect a version by acquiring the version of the program from the autonomous driving device before autonomous driving starts.

5. A vehicle management method that is performed by a vehicle management system including a first server, a second server, and a vehicle,
wherein the first server includes a first communication unit, a first control unit, and a first storage unit,
wherein the second server includes a second communication unit, a second control unit, and a second storage unit,
wherein the vehicle includes:
a vehicle functioning unit having functions for running, rotating, and stopping;
an autonomous driving device configured to be attachable to and detachable from the vehicle functioning unit, including a third communication unit configured to communicate with the first communication unit, at least one third control unit, and a third storage unit configured to store a program which is executed by the corresponding third control unit, and configured to issue an instruction for autonomous driving to the vehicle functioning unit;
a fourth control unit configured to output a control command for controlling the vehicle functioning unit; and
a fourth communication unit configured to communicate with the second communication unit,
wherein the vehicle management method comprises:
causing the first control unit of the first server to control the first communication unit such that updating data for updating a version of the program for the third control unit, which is stored in the first storage unit, is transmitted to the autonomous driving device of the vehicle;
causing the third control unit of the autonomous driving device of the vehicle to update the version of the program stored in the corresponding third storage unit using the updating data received from the first server by the third communication unit;
causing the fourth control unit of the vehicle to detect the version of the updated program of the third control unit;
causing the fourth control unit to control the fourth communication unit such that first identification information indicating the detected version is transmitted to the second server; and
causing the second control unit of the second server to recognize the version indicated by the first identification information received from the vehicle by the second communication unit as an updated version.
